(19) United States
(12) Patent Application Publication
(10) Pub. No.: US 2003/0043037 A1
(43) Pub. Date: Mar. 6, 2003

(54) System and method for preventing loss of an electrical device

(76) Inventor: Daniel Travis Lay, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/947,832

(22) Filed: Sep. 6, 2001

(51) Int. Cl. G08B 13/14

(52) U.S. Cl. 340/568.1; 340/686.6; 340/539

(57) ABSTRACT

The present disclosure relates to a system and method for preventing loss of an electrical device. In some arrangements, the system and method involve determination of whether the electrical device and the holster are within a predetermined distance of each other, and activating an alarm when it is determined that the electrical device and the holster are not within the predetermined distance of each other.

### FIELD OF THE INVENTION

The present disclosure relates to a system and method for preventing loss of an electrical device. More particularly, the disclosure relates to a mobile telephone and holster combination with which the user can be alerted that he or she is about to leave the mobile telephone behind.

### BACKGROUND OF THE INVENTION

Mobile telephone users often carry their telephones on their person so that they can make and answer calls as they travel from place to place. Many such mobile telephones are sold along with holsters that the user can attach to the user's clothing to facilitate easy carrying of the telephone.

When the user sets the mobile telephone down, it can be easy to forget to pick it back up before the user leaves the place at which the telephone was removed from its holster. This is particularly true with today's lightweight, compact mobile telephones. In such circumstances, the user may walk away, leaving the mobile telephone without realizing it is not in its holster. Due to the popularity of and demand for mobile telephones, particularly higher-end telephones, it is unlikely that the user will be able to reclaim the telephone once the user ultimately realizes he or she left it behind.

Accordingly, it can be appreciated that it would be desirable to have a system and method for preventing loss of a mobile telephone so that loss can be avoided before it occurs.

### SUMMARY OF THE INVENTION

The present disclosure generally relates to a system and method for preventing loss of an electrical device. In some arrangements, the method comprises the steps of determining whether the electrical device and the holster are within a predetermined distance of each other, and activating an alarm when it is determined that the electrical device and the holster are not within the predetermined distance of each other.

In some arrangements, the holster can comprise control circuitry, a power source electrically configured to provide power to the control circuitry, a receiver electrically connected to the control circuitry and adapted to receive radio frequency communications from the electrical device, and an alarm device that is activated by the control circuitry if signals are not received from the electrical device to alert the user that the electrical device is out of a predetermined range of the holster.

Other features and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view illustrating use of a system for preventing loss of a mobile telephone.

FIG. 2 is a schematic view of a mobile telephone and holster combination implementing the inventive system.

FIG. 3 is a schematic view of the architecture of the mobile telephone and holster shown in FIG. 2.

FIG. 4 is a flow diagram that illustrates a first method for preventing loss of a mobile telephone.

FIG. 5 is a flow diagram that illustrates a second method for preventing loss of a mobile telephone.

### DETAILED DESCRIPTION

Disclosed herein is a system and method for preventing loss of an electrical device, such as a mobile telephone. To facilitate description of the invention, an example mobile telephone and holster combination is described with reference to the figures. Although the telephone and holster are described with particularity, it will be appreciated that this description is provided for purposes of illustration only and that various modifications are feasible without departing from the inventive concept. After the mobile telephone and holster are described, examples of operation of the system are provided to explain the manners in which loss can be prevented.

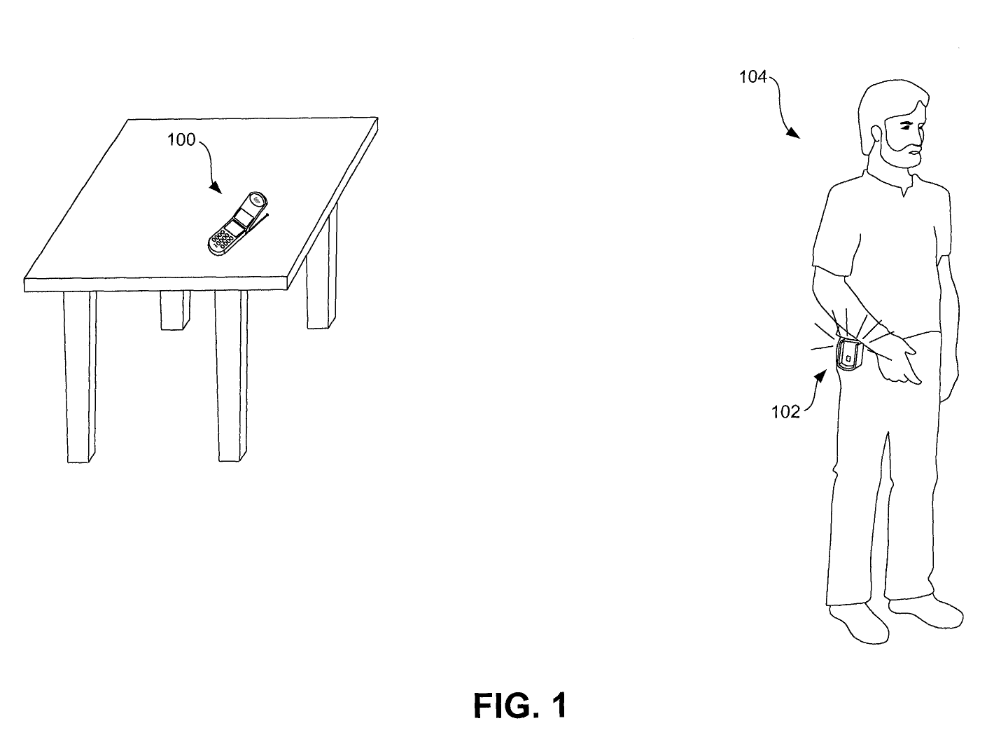

Referring now to the figures in which like numerals indicate corresponding components, FIG. 1 illustrates the general operation of the system for preventing loss of an electrical device. As indicated in this figure, the system can be implemented with a mobile telephone 100 and a holster 102 that is adapted to receive the telephone. The holster 102 is further adapted for attachment to the clothes of a user 104. For instance, the holster 102 can be adapted to attach to the user's clothes at the waist with a clip (not shown) provided on the reverse side of the holster.

Where the mobile telephone 100 is mislaid and the user begins to walk away from the mobile telephone, thereby leaving it behind, the holster 102 can sense this condition and, for instance, sound an alarm or otherwise alert the user that he or she has forgotten to pick up his or her mobile telephone. Although, as indicated in FIG. 1, it is the holster 102 that alerts the user as to this condition, it will be appreciated from the discussion that follows that the mobile telephone 100 can, alternatively or in addition, alert the user.

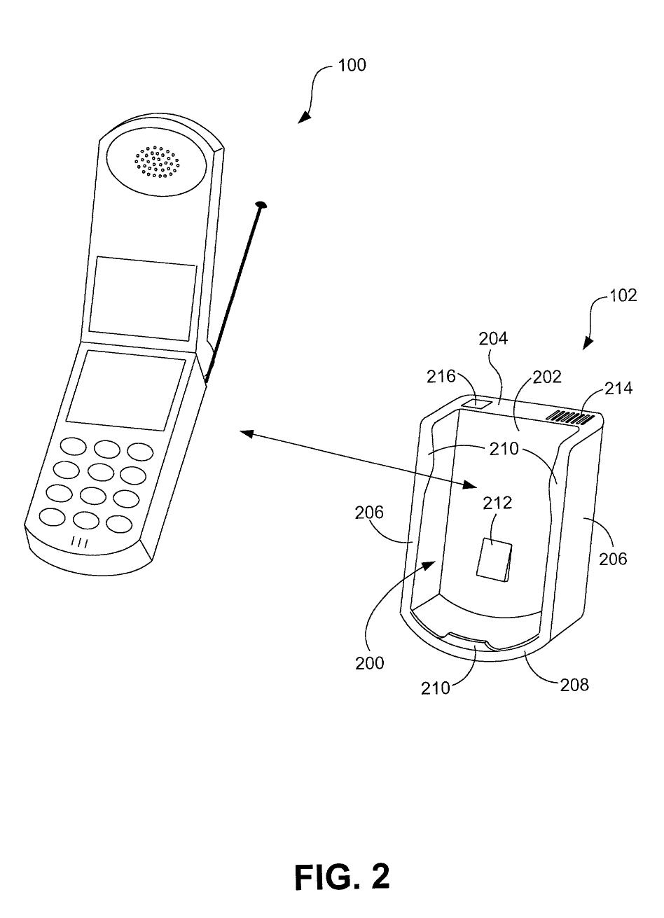

FIG. 2 illustrates the mobile telephone 100 and its accompanying holster 102 in greater detail. As indicated in this figure, the holster 102 can be configured so as to form a cavity 200 that is adapted for receipt of the mobile telephone 100. By way of example, this cavity 200 can be formed by a front surface 202 of a body 204 of the holster 102, opposed side walls 206 that extend outwardly from the body, and a base 208 that also extends outwardly from the body. The side walls 206 and base 208 can be provided with inwardly extending tabs 210 that are adapted to grip the mobile telephone 100 when it is disposed within the cavity 200 between the side walls 206.

As is further identified in FIG. 2, the holster 102 can include a sensor element 212 that, for instance, comprises an outwardly biased button that is provided on the front surface 202 of the holster body 204. For purposes described below, the sensor element 212 is adapted to sense when the mobile telephone 100 has been removed from the holster 102 so that the user can be alerted not to leave the telephone behind. Also provided on the holster body 204 is a speaker 214 and one or more lights 216. As described below, these components are used to alert the user.

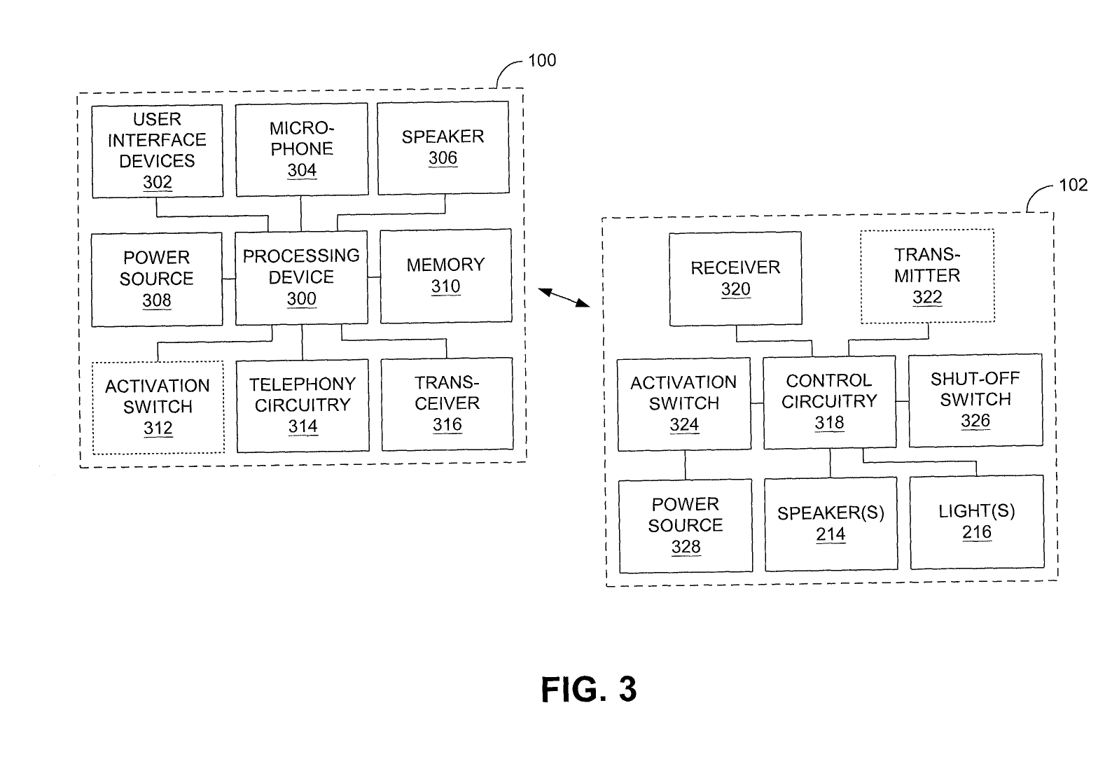

FIG. 3 is a schematic view illustrating example architectures for the mobile telephone 100 and the holster 102. Beginning with the mobile telephone 100, the architecture can include a processing device 300, user interface devices 302, a microphone 304, a speaker 306, a power source 308, memory 310, an activation switch 312, telephony circuitry 314, and a transceiver 316. The processing device 300 is adapted to execute commands stored in memory 310 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the mobile telephone 100.

The user interface devices 302 comprise those components with which the user can interact with the mobile telephone 100 to place calls, receive calls, and perform various other tasks with the telephone. As known in the art, these components typically comprise a plurality of alphanumeric buttons and various other buttons that control the operation of the telephone 100. The user interface devices 302 also typically include a display, for example a liquid crystal display (LCD), with which various information is communicated to the user such as numbers and digits entered by the user, signal strength, battery power, etc. The microphone 304 is provided to capture the user's voice during phone calls while the speaker 306 is adapted to emit sounds received by the telephone 100 so that the user can hear callers' voices and listen to voice mail messages. In addition, the speaker 306 can be used to emit an audible alarm where, as described below, the mobile telephone 100 is configured to alert the user that he or she is about to leave the telephone behind.

The power source 308 provides power to the mobile telephone 100 and typically comprises a rechargeable battery that is disposed within the telephone. The memory 310 typically includes any one of a combination of volatile memory elements (e.g., random access memory (RAM, such as DRAM, SRAM, etc.)) and is configured to store various information such as telephone numbers, telephone settings, etc. Where provided, the activation switch 312 is configured to enable or disable communications with the holster 102 when the system for preventing mobile telephone loss is used. By way of example, the activation switch 312 is linked to a sensor element (not shown) of the mobile telephone 100 that trips the switch when the mobile telephone is removed from the holster 102. The telephony circuitry 314 comprises the electrical circuits and other electrical components that facilitate the placing and receiving of telephone calls. In particular, the telephony circuitry 314 operates in conjunction with the transceiver 316 to transmit and receive radio frequency (RF) signals so that audio data can be sent and received with the telephone 100. In addition, as is described below, the telephony circuitry 314 and the transceiver 316 are configured to transmit, and in some embodiments receive, low power, low frequency radio transmissions to prevent the user from unintentionally leaving the telephone 100 behind.

Turning to the holster 102, the architecture typically includes control circuitry 318 that is configured to control operation of the holster when the mobile telephone 100 is removed from the holster cavity 200. The holster 102 also includes a receiver 320 and, in some embodiments, a transmitter 322, both of which are adapted for low power, short range RF communications. Where the holster 102 is configured to receive RF transmissions, the receiver 320 and the transmitter 322 can, optionally, be combined to form a transceiver (not indicated). Further included with the holster 102 is an activation switch 324 that is linked to the sensor element 212 shown in FIG. 2 such that the switch activates the control circuitry 318 when the mobile telephone 100 is removed from the cavity 200.

The holster 102 can also comprise a shut-off switch 326 that, as is discussed below, can be manipulated by the user to enable or disable the control circuitry 318 and any associated alarms that it generates. Powering the control circuitry 318 is a power source 328 that typically comprises an internal battery. As indicated in FIG. 3, the power source 328 can be is electrically connected to the control circuitry 318 via the activation switch 324 such that, when the switch is open, i.e. when the mobile telephone 100 is disposed within the cavity 200, power is not provided to the control circuitry. Audible alarms can be emitted from the holster 102 with the one or more speakers 214. In addition or in exception, the one more lights 216 (e.g., light emitting diodes (LEDs)) can also be used to alert the user that the user may be about to leave the mobile telephone 100 behind.

An example mobile telephone 100 and holster 102 having been described above, operation of the system for preventing loss of a mobile telephone will now be discussed. In the discussion that follows, flow diagrams are provided. It is to be understood that although particular example steps are described, alternative implementations are feasible. Moreover, steps may be executed out of order from that shown or discussed, including substantially concurrently or in reverse order, depending on the functionality involved.

As identified above, the system can be used to alert the user when the user is about to leave the mobile telephone 100 behind. More particularly, the system is configured to alert the user when the mobile telephone 100 is separated from the holster 102 more than a predetermined distance, indicating that the user potentially as mislaid the telephone. In a first example embodiment, the mobile telephone 100 is configured to emit low power, low frequency signals that are received by the holster 102 when the telephone is within a predetermined distance of the holster. The power of the signals emitted from the mobile telephone 100 such that the predetermined distance ranges from approximately ten to twenty feet. When the separation of the mobile telephone 100 and the holster 102 exceeds the predetermined distance, the signals expected by the holster 102 are not received, identifying to the holster 102 that the telephone is out of range. At this point, the holster 102 alerts the user as to this condition with one or more alarms (audible and/or visual) so that the user can avoid unintentionally leaving the mobile telephone 100 behind.

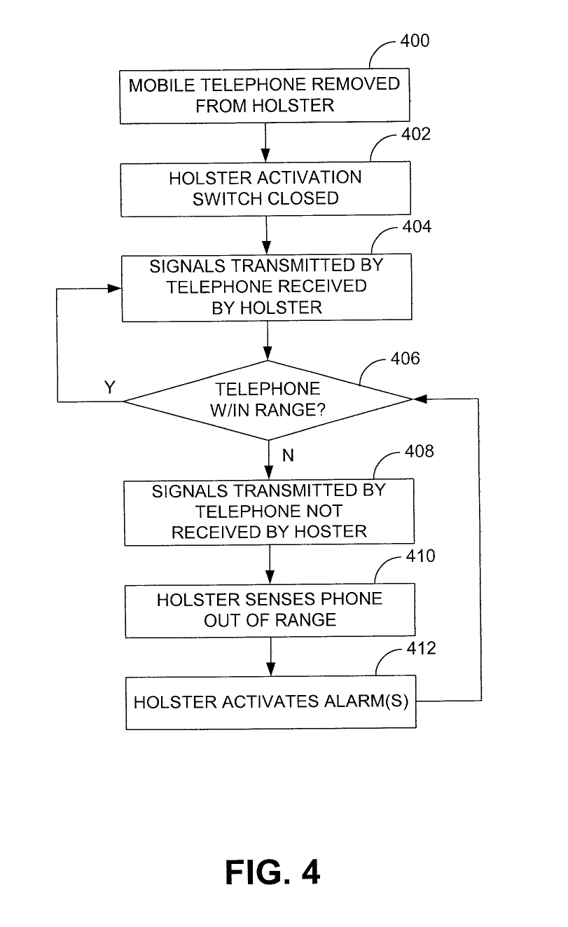

Referring now to FIG. 4, and example of operation in the first embodiment is provided. Beginning with block 400, the mobile telephone 100 is first removed from the holster 102. Once the telephone 100 is removed, the sensor element 212 is released and the activation switch 324 is closed, as indicated in block 402, thereby providing power to the control circuitry 318. Once power is provided to the control circuitry 318, the holster 102 awaits low frequency RF signals (i.e., pings) that are emitted by the mobile telephone 100 as confirmation that the telephone is within the predetermined distance of the holster. Where the mobile telephone 100 is also provided with a sensor element (not shown) and the activation switch 312, the telephone can likewise sense when it is removed from the holster 102 so that these signals are only transmitted by the telephone when needed.

By way of example, the signals can be transmitted by the mobile telephone 100 intermittently with a periodicity of a few seconds. Due to the periodic nature of these signals, and since the signals are relatively weak, the transmission of the signals normally requires little power from the power source 310 of the telephone 100, thereby avoiding undue power consumption. To provide greater control to the user over the transmission of the signals, signal transmission from the telephone 100 can be disabled, e.g., via the user interface devices 302, such that no transmissions occur. Such functionality is particularly useful where the user is in a controlled environment (e.g., the home) and the user is not concerned about losing the telephone 100. In a preferred arrangement, the signal transmissions, when enabled, occur irrespective of whether the mobile telephone 100 is “on” or “off” such that the user can be alerted even when the telephone is not powered-up for use.

The intermittent signals are transmitted by the mobile telephone 100 and, assuming the telephone is within range of the holster 102, received by the holster, as indicated in block 404. With reference to decision element 406, this exchange continues as long as the mobile telephone 100 and holster 102 are within the predetermined distance of each other. However, if the mobile telephone 100 and holster 102 are separated by more than the predetermined distance, the holster 102 will not receive the signals transmitted by the mobile telephone 100, as indicated in block 408, and the holster will therefore sense that the telephone is out of range, as indicated in block 410. In that the signals are intermittent, the holster 102 can be configured to only sense this condition when a signal has not been received for greater than a predetermined amount of time (e.g., three times the typical signal periodicity).

Once the out of range condition is sensed, the holster 102 reacts by activating one or more alarms for the user, as indicated in block 412. As noted above, these alarms can comprise an alarm sound that is emitted from the one or more speakers 214 and/or light signals emitted by the one or more lights 216. The alarm(s) will continue for the user until the user either manually shuts it/them off by tripping the shut-off switch 326 or until the mobile telephone 100 and holster 102 are again within range of each other. Alternatively, the holster 102 can be configured to activate the alarm(s) for a given length of time (e.g., a few seconds).

In a second example embodiment, the holster 102 is also configured to emit low power, low frequency call signals to the mobile telephone 100 to request confirmation, in the form of a confirmation signal, that the telephone is within range. In this embodiment, when the separation between the mobile telephone 100 and the holster 102 exceeds the predetermined distance, the call signals transmitted by the holster 102 and/or the confirmation signals transmitted by the telephone are not received, thereby prompting to the holster 102 to alert the user as to this condition.

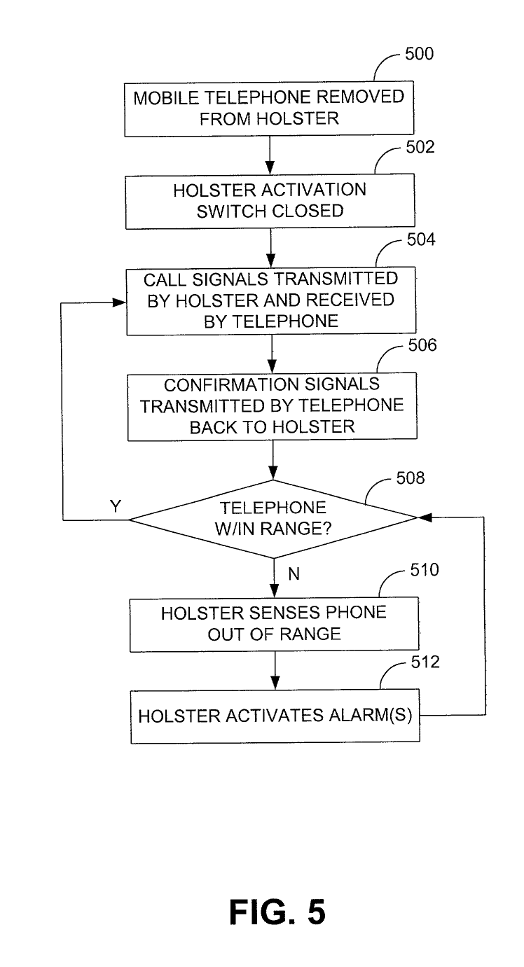

With reference to FIG. 5, an example of operation with the second embodiment is provided. Beginning with block 500, the mobile telephone 100 is first removed from the holster 102. Again, the sensor element 212 of the holster 102 is released, closing the activation switch 324, as indicated in block 502, thereby providing power to the holster control circuitry 318. Once power is provided to the control circuitry 318, the holster 102 begins transmitting intermittent, low frequency RF call signals that are received by the mobile telephone 100, as indicated in block 504, which request confirmation that the telephone is still within range. As before, the signals can be transmitted periodically in increments of a few seconds without undue drain on the power source 328.

Referring to block 506, the mobile telephone 100 responds to the received call signals with confirmation signals that are transmitted to the holster 102. With reference to decision element 508, these communications continue as long as the mobile telephone 100 and holster 102 are within the predetermined distance of each other. However, if the mobile telephone 100 and holster 102 are separated by more than the predetermined distance, the mobile telephone 100 will not receive the call signals transmitted by the holster 102 and/or the holster will not receive the confirmation signals transmitted by the telephone. In either case, the holster 102 senses that the telephone 100 is out of range, as indicated in block 510. Once the out of range condition is sensed, the holster 102 reacts by activating one or more alarms for the user, as indicated in block 512, in the manner described above. Again, the alarm(s) will continue for the user until the user either manually shuts it/them off by tripping the shut-off switch 326 or until the mobile telephone 100 and holster 102 are again within range of each other.

While particular embodiments of the invention have been disclosed in detail in the foregoing description and drawings for purposes of example, it will be understood by those skilled in the art that variations and modifications thereof can be made without departing from the scope of the invention as set forth in the following claims. For instance, although the alarms have been described as being emitted from the holster 102, persons having skill in the art will appreciate that in addition or exception, the mobile telephone 100 can be configured for alarm activation. In such an embodiment, communications between the mobile telephone 100 and the holster 102 are reversed from those described above in either embodiment. In addition, although the alarms have been described as comprising audible and visual alarms, it is to be appreciated that other types of alarms (e.g., vibratory) could be used, if desired. Furthermore, although the system and method have been described as being specifically implemented with a mobile telephone and holster, it will be understood that the concepts disclosed herein also apply to apply to pagers and pager holsters as well as to substantially any other portable device adapted for carrying with a holster.

What is claimed is:

1. A holster adapted to receive an electrical device, comprising:
control circuitry;
a power source adapted to provide power to the control circuitry;
a receiver electrically connected to the control circuitry and adapted to receive radio frequency communications from the electrical device; and
an alarm device that is activated by the control circuitry if signals are not received from the electrical device to alert the user that the electrical device is out of a predetermined range of the holster.

2. The holster of claim 1, wherein the alarm device comprises a speaker that is adapted to emit an audible alarm.

3. The holster of claim 1, wherein the alarm device comprises a light that is adapted to provide a visual alarm.

4. The holster of claim 1, further comprising a sensing element and an activation switch, the sensing element being adapted to sense when the electrical device is removed from the holster and the activation switch being adapted to permit power from the power source to reach the control circuitry when the sensing element senses that the electrical device has been removed.

5. The holster of claim 1, further comprising a shut-off switch that can be manipulated to disable an alarm.

6. The holster of claim 1, further comprising a transmitter adapted to transmit radio frequency signals to the electrical device.

7. An electrical product, comprising:
an electrical device having a transmitter adapted to transmit radio frequency signals; and
a holster adapted to receive the electrical device, the holster including control circuitry, a power source adapted to provide power to the control circuitry, a receiver electrically connected to the control circuitry and adapted to receive radio frequency communications from the electrical device, and an alarm device that is activated by the control circuitry if signals are not received from the electrical device to alert the user that the electrical device is out of a predetermined range of the holster.

8. The product of claim 7, wherein the alarm device comprises a speaker that is adapted to emit an audible alarm.

9. The product of claim 7, wherein the alarm device comprises a light that is adapted to provide a visual alarm.

10. The product of claim 7, wherein the holster further comprises a sensing element and an activation switch, the sensing element being adapted to sense when the electrical device is removed from the holster and the activation switch being adapted to permit power from the power source to reach the control circuitry when the sensing element senses that the electrical device has been removed.

11. The product of claim 7, wherein the holster further comprises a shut-off switch that can be manipulated to disable an alarm.

12. The product of claim 7, wherein the holster further comprises a transmitter adapted to transmit radio frequency signals to the electrical device.

13. The product of claim 7, wherein the electrical device further comprises a receiver that is adapted to receive signals transmitted by the holster.

14. The product of claim 7, wherein the electrical device further comprises a speaker that is adapted to emit an audible alarm.

15. The product of claim 7, wherein the electrical device further comprises an activation switch that enables communications with the holster when the electrical device is removed from the holster.

16. The product of claim 7, wherein the electrical device comprises a mobile telephone.

17. A method for preventing loss of an electrical device that is adapted for receipt in a holster, comprising the steps of:
determining whether the electrical device and the holster are within a predetermined distance of each other; and
activating an alarm when it is determined that the electrical device and the holster are not within the predetermined distance of each other.

18. The method of claim 17, wherein the step of determining whether the electrical device and the holster are within a predetermined distance of each other comprises transmitting signals with the electrical device for receipt by the holster.

19. The method of claim 17, wherein the step of determining whether the electrical device and the holster are within a predetermined distance of each other comprises transmitting call signals with the holster, receiving the transmitted signals with the electrical device, and transmitting confirmation signals with the electrical for receipt by the holster.

20. The method of claim 17, wherein the step of activating an alarm comprises activating an alarm with the holster.

21. The method of claim 17, wherein the step of activating an alarm comprises activating an alarm with the electrical device.

22. The method of claim 17, wherein the step of activating an alarm comprises activating an audible alarm.

23. The method of claim 17, wherein the step of activating an alarm comprises activating a visual alarm.

24. The method of claim 17, wherein the electrical device comprises a mobile telephone.
